(19) United States
(12) Patent Application Publication
(10) Pub. No.: US 2025/0111596 A1
(43) Pub. Date: Apr. 3, 2025

(54) Dynamic Transparency of User Representations

(71) Applicant: Apple Inc., Cupertino, CA (US)

(72) Inventors: Tong CHEN, Bellevue, WA (US); Jonathan PERRON, Felton, CA (US); Shih-Sang CHIU, Menlo Park, CA (US)

(21) Appl. No.: 18/897,298

(22) Filed: Sep. 26, 2024

Related U.S. Application Data
(60) Provisional application No. 63/586,602, filed on Sep. 29, 2023.

(51) Int. Cl. G06T 15/50; G06F 3/01; G06T 7/50; G06T 13/40

(52) U.S. Cl. CPC G06T 15/503; G06F 3/012; G06T 7/50; G06T 13/40; G06T 2207/30196; G06T 2210/08; G06T 2210/62

(57) ABSTRACT

Generating a 3D representation of a subject includes obtaining image data of a subject, obtaining tracking data for the subject based on the image data, and determining, for a particular frame of the image data, a velocity of the subject in the image data. A transparency treatment is applied to a portion of the virtual representation in accordance with the determined velocity. The portion of the virtual representation to which the transparency treatment is applied includes a shoulder region of the subject.

### BACKGROUND

Computerized characters that represent users are commonly referred to as avatars. Avatars may take a wide variety of forms including virtual humans, animals, and plant life. Existing systems for avatar generation tend to inaccurately represent the user, require high-performance general and graphics processors, and may not work well on power-constrained mobile devices, such as smartphones or computing tablets.

### BRIEF DESCRIPTION OF THE DRAWINGS

FIG. 1 shows a diagram of a technique for presenting a virtual representation of a subject with a dynamic transparency treatment, according to some embodiments.

FIG. 2 shows a flowchart of a technique for determining a 3D representation of a subject from which regions of a 3D representation of a subject, according to one or more embodiments.

FIG. 3 shows a diagram of different regions of a representation of a subject having different levels of transparency, in accordance with some embodiments.

FIG. 4 shows a flow diagram for dynamically modifying transparency of a virtual representation of a subject, in accordance with some embodiments.

FIG. 5 depicts a flowchart of a technique for dynamically modifying transparency of a portion of a virtual representation of a subject, in accordance with one or more embodiments.

FIG. 6 shows, in block diagram form, a simplified system diagram according to one or more embodiments.

FIG. 7 shows, in block diagram form, a computer system in accordance with one or more embodiments.

### DETAILED DESCRIPTION

This disclosure relates generally to techniques for avatar presentation with dynamic transparency. More particularly, but not by way of limitation, this disclosure relates to techniques and systems dynamically modifying a transparency level for a portion of the avatar based on velocity.

This disclosure pertains to systems, methods, and computer readable media to present an avatar in a manner such that a portion of the avatar is presented with a dynamic level of transparency based on a velocity of a corresponding subject. The subject of the avatar can be represented by a geometry, such as a 3D mesh. A portion of the geometry may be assigned a dynamic level of transparency based on a velocity of the user, such that the visibility of the avatar corresponding to the portion of the geometry changes based on a movement of the user. As an example, as a user shifts from left to right, a shoulder portion may become more or less visible than when the user is stationary.

The portion of the geometry of the subject to which the transparency treatment is applied may be based on a number of factors. For example, the portion of the geometry may be predefined based on characteristics of the portion, such as a shoulder portion of a subject. As another example, the portion of the geometry of the subject to which the transparency treatment is applied may be based on regions of an avatar associated with a low confidence value. As yet another example, the geometry of the subject may include a portion which has been predicted based on image or other captured sensor data of the subject, and a portion which has been predefined, or otherwise not fully predicted. As an example, a portion of the geometry which corresponds to a region of the subject which is not well captured, such as a shoulder region, may be replaced with a generic version of the region, such as an imposter shoulder region, which has been stitched to and/or scaled to match the portion of the geometry corresponding to a region of the subject which is well captured. The dynamic transparency treatment may be applied to this replacement portion of the avatar geometry, in accordance with some embodiments.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood to refer necessarily to the same embodiment or to different embodiments.

It should be appreciated that in the development of any actual implementation (as in any development project), numerous decisions must be made to achieve the developers' specific goals (e.g., compliance with system and business-related constraints) and that these goals will vary from one implementation to another. It should also be appreciated that such development efforts might be complex and time-consuming but would nevertheless be a routine undertaking for those of ordinary skill in the art of image capture having the benefit of this disclosure.

Embodiments described herein allow a user to interact in an extended reality (XR) environment using a subject persona. A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

For purposes of this application, the term “persona” refers to a virtual representation of a subject that is generated to accurately reflect the subject's physical characteristics, movements, and the like.

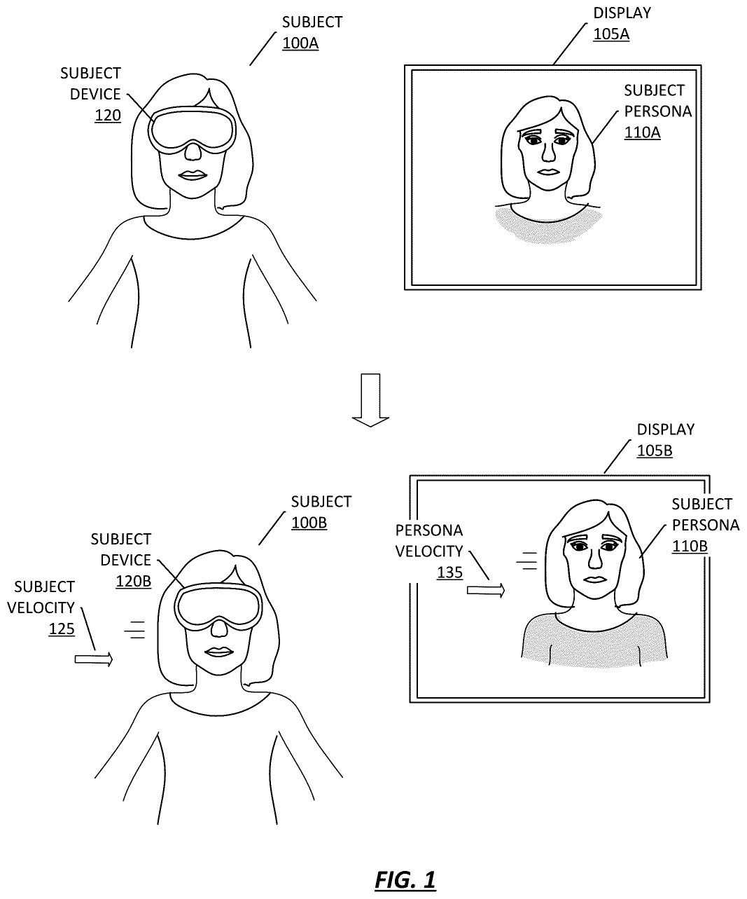

Turning to FIG. 1, a diagram is shown of the result of a technique for dynamically modifying transparency of an avatar based on velocity of the avatar. A subject 100A wears a device 120 which captures sensor data from which a virtual representation of the user can be generated. As a result, a virtual representation of the user, depicted as persona 110A, is presented on a display 105A. The display 105A may be part of an electronic device, such as the electronic device of a second user participating in a copresence session with the subject 100A. That is, a remote user may view the subject persona 110A on the remote user's device such that the subject persona 110A provides a virtual representation of current characteristics of the subject 100A, such as visual characteristics, movement, audio, or the like.

According to one or more embodiments, a virtual representation of a subject will be presented differently depending upon a velocity or other movement characteristics of the subject. For example, in some embodiments, a transparency of a portion of the virtual representation may change depending upon a velocity of the subject represented by the virtual representation. In FIG. 1, the subject 100A is currently in a stationary manner. Accordingly, the subject persona 110A presented on display 105A may display a subset of representation of the subject 100A. That is, a portion of the subject persona 110A is made transparent in accordance with the velocity (or, in this case, lack of velocity) of the subject 100A. In some embodiments, the velocity of the subject 100A may be determined based on sensors within the subject device 120. For example, the subject device 120 may include image sensors which capture image data from which computer vision techniques can be applied to determine velocity. As another example, subject device 120 may include one or more sensors that track motion such as an inertial measurement unit (IMU), accelerometer, gyroscope, or the like. As such, the velocity of the subject 100A may be determined based on the velocity of the subject device 120. In some embodiments, other measurements of motion may be used to modify transparency of a digital representation of the subject. For example, acceleration, rotation, or the like may additionally or alternatively be used. The subject device 120, or other electronic device communicably coupled to the electronic device 120 can utilize the sensor data related to velocity (or other motion measurement) to modify a transparency of at least a portion of the virtual representation.

According to one or more embodiments, the portion of the virtual representation of the user which is dynamically made more or less transparent may be based on a quality of data for the corresponding portion of the virtual representation. In the example shown, the shoulder region of the subject 100A may be more difficult to accurately track and represent in an avatar or other virtual representation based on the captured data. For example, while the electronic device 120 may have cameras facing toward the subject's face, data regarding the subject's shoulders may be lacking. This may occur, for example, because a portion of the subject (such as the shoulders) is not captured by sensors of the electronic device 120, or the captured sensor data of the portion of the subject is of a lower quality than sensor data captured of other portions of the subject such as the face. According to some embodiments, the lack of sensor data at a higher quality level around the shoulders may cause a representation of the shoulders to be less accurate or realistic than other portions of the subject where more or better quality sensor data is available, such as the face. As another example, a region including the user's hair or perimeter of the user's hair may also be less accurately tracked than other portions of the user and, thus, may be dynamically rendered with a transparency treatment in accordance with a tracked velocity or other motion measurement of the user.

The rendering and/or presentation of the virtual representation of the subject may be modified dynamically during runtime based on movement characteristics. Subject 100B shows a version of the subject which is moving from left to right, shown by subject velocity 125. The subject 100B is using a mobile device 120B. Mobile device 120B is a separate view of mobile device 120A while the subject is moving. According to one or more embodiments, the mobile device 120B may be a head mounted device or other wearable device. The mobile device 120B may include one or more sensors from which velocity of the subject and/or device may be determined. For example, computer vision techniques can be used to track the velocity of the shoulders. In some embodiments, a velocity of the device will be measured and used as a proxy for a velocity of the person wearing the device. The velocity may be determined, for example, based on measurements from an IMU device within the mobile device, or using other localization information such as GPS, VIO, or the like. According to one or more embodiments, translational velocity may be used to determine whether to modify a transparency level of a portion of the user. Accordingly, the velocity determination may be adjusted or filtered such that the velocity in a particular direction can be determined, such as with a side-to-side movement from the perspective of a viewer.

The velocity measurements captured by the mobile device 120B can be used to modify transmission of avatar data or other virtual representation data of the subject 100B for presentation on a display 105B at a remote device. Additionally, or alternatively, the velocity measurements captured by the mobile device can be used to modify transparency characteristics of the virtual representation of the subject 110B prior to transmission. In one or more embodiments, regions of the virtual representation which are associated with a lower quality level may be rendered more transparently than regions associated with a higher quality level when the velocity of the subject is below a threshold. According to one or more embodiments, increasing the transparency of the regions associated with a lower quality level while a subject is still or is moving at a rate below a threshold reduces presentation of low quality presentation. The transparency may be reduced when the subject is moving or is moving at a rate above a threshold value where the details of the low quality region may be less noticeable, but whose presence provides additional context to the shape of the user. Thus, as shown in display 105B, subject persona 110B is shown with the shoulder region present. That is, whereas the shoulder region is transparent in subject persona 110A, the shoulder region is visible in subject persona 110B in accordance with subject velocity 125. Because the virtual representation of the subject 105B is generated to reflect an honest or accurate representation of the physical and movement characteristics of the subject 100B, subject persona 110B is presented as moving at a persona velocity 135 which, according to one or more embodiments, reflects the subject velocity 125.

Because display 105B presents the subject persona 110B to a user of the remote device, the user of the remote device views the subject persona 110B moving in accordance with the persona velocity 135. Because the subject persona 110B is in motion, a viewer of the display 105 may be less likely to recognize that some regions of the representation are either presented in lower quality, or generated based on lower quality data, than other regions. For example, the reduced quality of the shoulder region as compared to the face may be less apparent while the subject persona 110B is in motion. At the same time, presenting the shoulder region provides a viewer of display 105 with additional context of the subject 120B. As such, the shoulder region is presented while the subject persona 110B is moving to enhance the presentation of the subject persona 110B and the user experience of a viewer of display 105.

As shown in the example depicted in FIG. 1, some embodiments are directed to dynamically modifying a transparency of a region when a subject is in motion by making certain regions of the subject transparent when the subject is moving. For example, some embodiments may be directed to dynamically modifying a transparency of a region when a subject is in motion by making unreliable regions less transparent when the subject is moving.

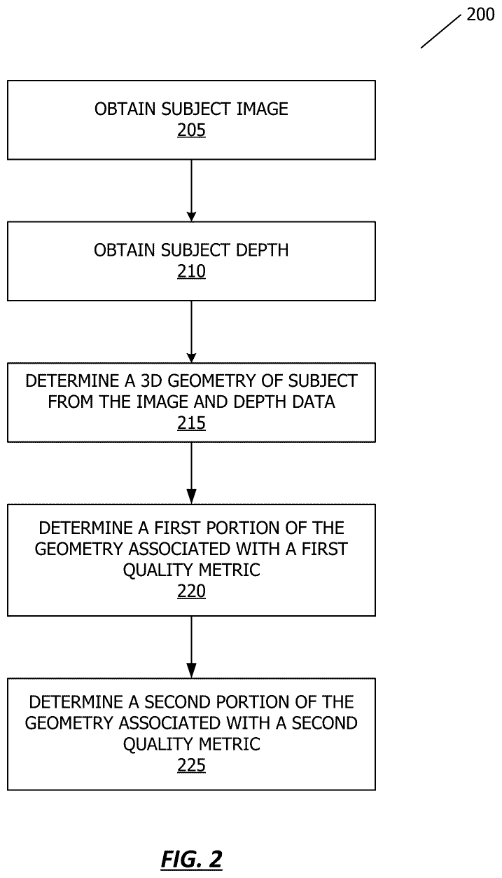

FIG. 2 shows a flowchart of a technique for generating a representation of a subject having multiple regions, for example during an enrollment process, according to one or more embodiments. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart 200 begins at block 205 where an image of a subject is obtained. The input image may include a visual image of the subject. The image data may be obtained by a single camera or camera system, such as a stereo camera, or other set of synchronized cameras configured to capture image data of a scene in a synchronized manner. According to some embodiments, the image may be a 2D image, or may have 3D characteristics, for example if the image is captured by a depth camera.

The flowchart 200 continues to block 210, where depth information for the subject is obtained. According to some embodiments, the depth information is used to derive a 3D representation of the subject. In some embodiments, the front depth data may be determined from the subject image captured in block 205, for example if the image is captured by an image camera, a depth camera, or is otherwise provided/obtained. Alternatively, the front depth data may be captured from alternative sources. For example, sensor data may be captured from a separate depth sensor on the device, and may be used to determine depth information for the surface of the subject facing the sensor. In some embodiments, a combination of the image data and the depth sensor data may be used. According to one or more embodiments, while the sensor data may not directly capture depth information for a back surface of the user (i.e., the surface of the user facing away from the sensors), the back depth data can be derived from the front depth data. This may occur, for example, by using a network that considers the image and/or the front depth data to predict back depth data. According to one or more embodiments, the image data and/or depth data captured to generate the 3D virtual representation may be captured during an enrollment process, during runtime, or some combination thereof. As such, the virtual representation may be generated based on enrollment data captured or generated for the subject such as geometry, texture, and the like.

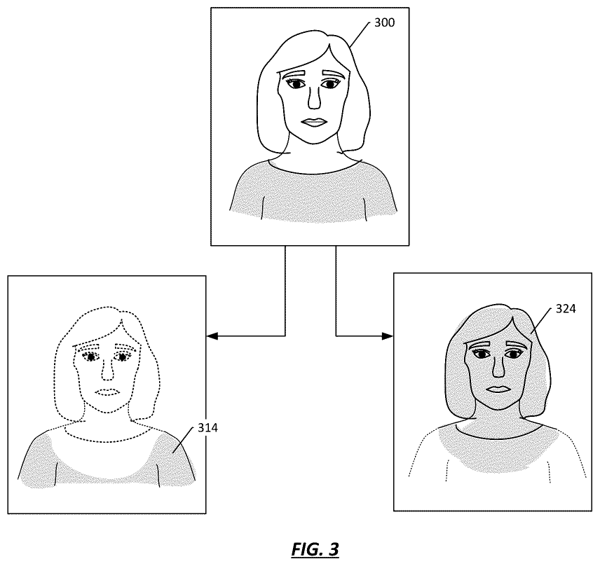

The flowchart 200 proceeds to block 215, where a 3D representation of the subject can then be determined from the depth and image data. In some embodiments, pixel-aligned implicit functions (“PIFu”) may be used to obtain the classifier value for each sample point, from each image. Alternatively, other techniques can be used to derive a 3D representation of a subject based on image data and/or depth data. The 3D representation may be in the form of a 3D mesh, a point cloud, or other representation of the 3D geometry of the user. In some embodiments, the 3D representation of the subject can also include texture information such as the visual qualities of the virtual representation. Turning to FIG. 3, virtual representation 300 shows an example virtual representation derived from image and/or depth data, from which different portions can be identified for varying levels of transparency.

At block 220, a first portion of the geometry is associated with a first quality metric. In particular, a portion of the 3D geometry is determined for which a level of transparency is dynamically modified based on motion characteristics of the user. In some embodiments, the first portion of the geometry may be a predefined portion. For example, a shoulder region, hair region, or the like may be identified, for example based on the image data or depth data, and assigned as the first portion of the geometry. As an example, returning to FIG. 3, shoulder region 314 may be identified as the first region. Alternatively, the first portion of the geometry may include a portion of the geometry derived from low or reduced quality data, either captured during an enrollment process, or for which image data is limited during a real time representation in a copresence environment. That is, the first portion may be identified based on the quality of the image data or depth data for the particular region of the subject, or based on predetermined knowledge of the limitations of camera configurations or other sensors with respect to the position of the user's body part during a real-time image captured in a copresence environment. For example, returning to FIG. 1, the sensors may be located in subject device 105 and may not include downward facing sensors that would accurately track shoulder movement or other characteristics.

The flowchart 200 concludes at block 225, where a second portion of the geometry is determined as having a second quality metric. In some embodiments, the second portion of the geometry may include a remaining portion of the 3D geometry of the subject without consideration of the first portion determined at block 220. Alternatively, the second portion may be determined as a portion for which a transparency is not affected by motion characteristics of the user. For example, a facial region, upper torso, or the like may be identified, for example based on the image data or depth data, and assigned as the second portion of the geometry. As an example, returning to FIG. 3, face and upper torso region 324 may be identified as the second region. Alternatively, the second portion of the geometry may include a portion of the geometry derived from high or increased quality data. That is, the first portion may be identified based on the quality of the image data or depth data for the particular region of the subject, or based on predetermined knowledge of the capabilities of camera configurations or other sensors with respect to the position of the user's body part during a real-time image captured in a copresence environment. For example, returning to FIG. 1, the sensors may be located in subject device 105 and may include user-facing sensors directly in front of the user's face that would accurately track face movement or other characteristics.

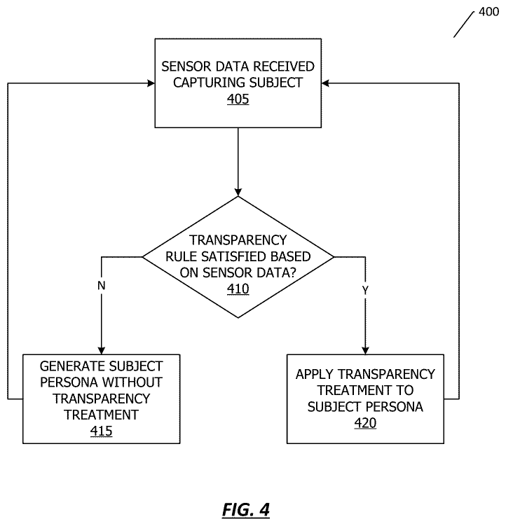

Turning to FIG. 4, a flowchart for dynamically modifying transparency of a virtual representation of a subject is presented, in accordance with some embodiments. In particular, flowchart 400 depicts an example technique for dynamically determining how transparency should be applied to particular region of a persona or other virtual representation of a subject during runtime. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart 400 begins at block 405 where sensor data is received that captures a subject. The sensor data may be captured, for example, by one or more sensors on a device worn by the user, or by a separate device capturing sensor data of the user. In some embodiments, the sensor data may include data to drive a virtual representation of the subject and may include image data, depth data, motion data, or the like. The sensor data may include, for example a visual image of the subject. The image data may be obtained by a single camera or camera system, such as a stereo camera, or other set of synchronized cameras configured to capture image data of the subject. According to some embodiments, the image data may include 2D image data, or may have 3D characteristics, for example if the image is captured by a depth camera. In addition, depth sensor data may be captured by one or more depth sensors captured coincident with the image data. The image data and depth data may be used by a persona framework to generate or drive a virtual representation of a user. According to one or more embodiments, the sensors used to capture sensor data to drive the virtual representation of the user may be the same or different than the sensors described above with respect to blocks 205 and 210 of FIG. 2 which are used to determine a 3D geometry of a user. In addition, the sensors may be included on a same or different electronic device.

According to one or more embodiments, the sensor data may additionally include data related to the user's motion. For example, sensor data may include a velocity of the user. An electronic device may include one or more sensors from which velocity of the subject and/or device may be determined. That is, computer vision techniques can be used to capture image data of a portion of the subject and determine velocity based on the image data. In some embodiments, a velocity of the device will be measured and used as a proxy for a velocity of the person wearing the device, such as when the sensors are part of a wearable device donned by the subject. The velocity may be determined, for example, based on measurements from one or more sensors that tracks motion such as an inertial measurement unit (IMU), accelerometer, gyroscope, or the like, or using other localization information such as GPS, VIO, or the like.

The flowchart 400 continues to block 410, where a determination is made as to whether a transparency rule is satisfied based on the sensor data. In accordance with one or more embodiments, different portions of the user representation may be associated with different metrics for applying transparency. According to one or more embodiments, the transparency rule may include a threshold velocity. That is, the velocity of at least a portion of the subject is determined to be moving greater or less than a threshold velocity, for example, based on the sensor data captured at block 405, current velocity of at least a portion of the subject may be compared to a threshold velocity to determine whether the transparency rule is satisfied. According to one or more embodiments, the transparency rule may refer to particular characteristics of the velocity. For example, a translational velocity of at least a portion of the subject may be considered, such as a side-to-side motion, or a motion which results in the subject persona appearing to move across a display of a viewer. As such, the transparency rule may include a directional component. In some embodiments, the transparency rule may rely on additional parameters, or may be specific to a particular region of a virtual representation of a subject. For example, different portions of a virtual representation of a subject may be associated with different transparency rules.

If at block 410 a determination is made that the transparency rule is not satisfied, then the flowchart proceeds to block 415 and the subject persona is generated without a transparency treatment. According to one or more embodiments, virtual representation data may be sent from a first device capturing the subject to a second device presenting the subject persona. In some embodiments, the determination as to whether the transparency rule is satisfied may occur on a sending device. That is, a device that captures the sensor data of the subject may collect and transmit virtual representation data, such as geometry, movement, and texture. The device may use sensor data to determine the velocity of the subject and in response to the velocity not satisfying a transparency rule, forgo application of a transparency treatment. Generating the subject persona without transparency treatment involves transmitting virtual representation data of the subject to the second device without applying a transparency treatment. In some embodiments, the determination as to whether the transparency rule is satisfied may occur on a receiving device. That is, a device that receives the virtual representation data, such as geometry, movement, and texture, can render the subject persona for presentation. Generating the subject persona without transparency treatment may rendering the entire geometry and/or texture without applying a transparency treatment based on a determined velocity measure for the subject. Accordingly, the subject persona is rendered and displayed at the receiving device without any modifications based on the transparency rule.

Returning to block 410, if a determination is made that a transparency rule is satisfied, then the flowchart 400 proceeds to block 420. At block 420, a transparency treatment is applied to the subject persona. In some embodiments, applying the transparency treatment may be performed by a device capturing and sending the virtual representation data, or by a receiving device rendering and displaying the subject persona based on the virtual representation data. According to one or more embodiments, applying a transparency treatment to the subject persona at a sending device may involve reducing the data transmitted to the receiving device in accordance with the portion of the virtual representation to which a transparency treatment is applied. That is, if the sender device is aware that the transparency treatment is to be applied to one or more frames, the sender device can either not send the data associated with the region, or preprocess the data, for example by encoding the data differently to conserve resources and/or bandwidth. In some embodiments, the sender device adjusts an alpha value for the region to indicate a level of transparency at which the region is to be rendered. In some embodiments, the transparency treatment is applied at the receiving device. The receiving device may receive an indication of a motion of the user and determine that the transparency rule is satisfied. Alternatively, the receiving device may receive an indication that the transparency rule is satisfied. The receiving device may then render the subject persona by applying a transparency treatment may involve applying a shader to the portion of the subject persona which is configured to remove image content based on the velocity or other parameters associated with the transparency rule. In some embodiments, a transparency parameter, such as an alpha value, may be determined based on the sensor data. As an example, the amount of transparency may be based on a velocity or other characteristic of the motion of the subject, such as increasing the transparency as the velocity of the subject slows down. According to one or more embodiments, an additional shader may be applied to the subject persona to smooth a boundary between the first region and the second region.

The flowchart 400 then returns to block 405 and the process continues as additional sensor data is captured of the subject. That is, a portion of the subject persona can have different levels of transparency over different frames in accordance with a velocity or other motion parameter of the subject.

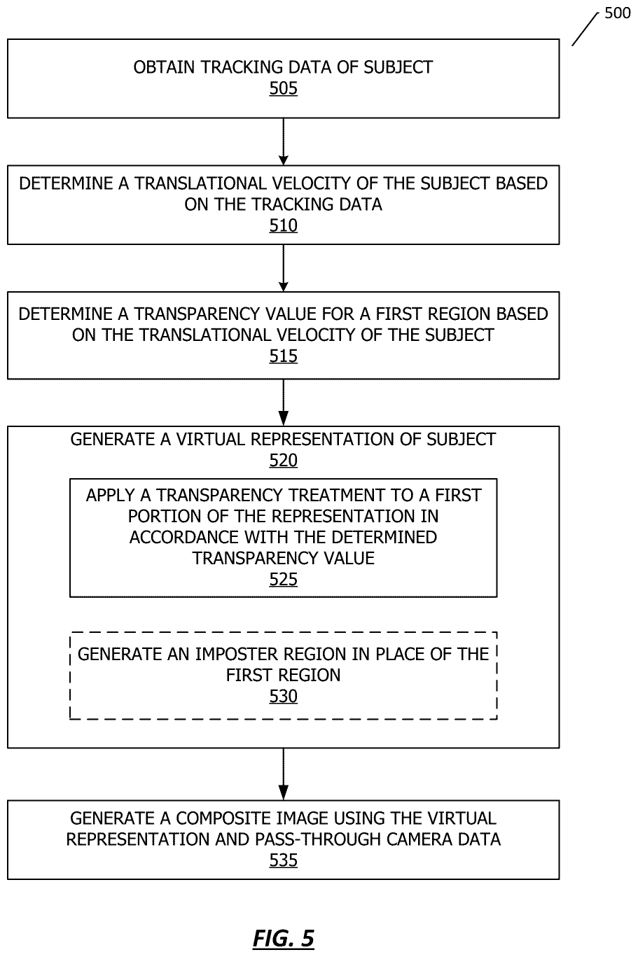

FIG. 5 depicts a flowchart of a technique for dynamically modifying transparency of a portion of a virtual representation of a subject, in accordance with one or more embodiments. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart 500 begins at block 505, where tracking data of the subject is obtained. Tracking data may be obtained during runtime while a user of a device is using the device to capture sensor data for generating a virtual representation of the user for presentation at a second device. According to one or more embodiments, the tracking data may include image data, depth data, motion data, and the like.

The flowchart 500 proceeds to block 510, where a translational velocity of at least a portion of the subject is obtained. According to one or more embodiments, the subject may be the user donning a wearable device, such as a head mounted device which is capturing the tracking data. The head mounted device may include a sensor capturing user motion such as a camera, IMU, accelerometer, or the like. The translational velocity of the subject may include a side-to-side motion, or a motion which results in at least a portion of the subject persona appearing to move across a display of a viewer.

The flowchart 500 proceeds to block 515, where a transparency value is determined for a first region based on the translational velocity of the subject. In some embodiments, the transparency value may be determined based on the translational velocity satisfying a transparency rule. For example, a threshold velocity may be considered which, when satisfied by the subject, causes a transparency treatment to be applied to a portion of the virtual representation of the subject. In some embodiments, different transparency values, and different transparency rules, may be used for multiple regions of the virtual representation of the subject. For example, while a face of the subject may be still, some transparency rules may indicate that the face should never be rendered transparent.

At block 520, an avatar representation of the subject is generated. According to one or more embodiments, a device may use the tracking information and generate the virtual representation of the subject performing the tracked movements in the form of a subject persona. The virtual representation of the subject may be based, in part, on the 3D mesh derived from the volume of the subject as described above with respect to block 215 of FIG. 2. In addition, the tracked movements of the subject may be represented by movements of the subject persona. Generating the avatar representation includes, as shown at block 525, applying a transparency treatment to a first portion of the representation in accordance with the determined transparency value. According to one or more embodiments, the transparency treatment may be applied by adjusting an alpha value for a region of the image including the first portion of the representation such that when the virtual representation is rendered in a composite image, image content from the first portion is removed, thereby allowing the underlying environment image, such as pass-through camera images, to shine through. This may be achieved by applying a mask to the portion of the content including the first portion of the representation to which the alpha values are applied and/or adjusted.

Optionally, as shown at block 530, an imposter region is obtained or generated to be presented in place of the first region. For example, image data and/or geometry of a generic or predefined shoulder region may used to augment the virtual representation of the subject. The imposter region may include a subject-generic image of the region such that the image data and/or geometry does not belong to the user, but is a generic version of the first region which has been predefined. As another example, the imposter region may be specific to the subject. For example, a predefined subject-specific imposter region may be generated from sensor data captured during an enrollment process. For example, when the subject enrolls to generate persona data for use during runtime, more sensor data, or better quality sensor data, may be captured of the subject than that captured during runtime, such as during a tracking stage. As such, the enrollment data may be used to generate a subject-specific imposter region which can be used to augment the virtual representation in place of the first portion to which the transparency treatment is applied. A hybrid approach may also be taken. For example, subject-specific measurements may be captured either during enrollment or during runtime, for example related to a shoulder width for the particular subject, a shoulder position of the particular subject, or the like. The subject measurement may be used to modify a subject-generic imposter region to generate a modified subject-generic imposter region which can be used to augment the virtual representation in place of the first portion to which the transparency treatment is applied.

The flowchart concludes at block 535, where a composite image is generated using the virtual representation of the subject in a 3D environment for presentation at a receiving device. For example, a graphics hardware or other component of the receiving device may blend the virtual representation with locally-captured pass-through camera content such that they appear in a single image. In some embodiments, the composite image will allow the pass-through camera data to become visible underneath the first portion of the virtual representation of the subject in accordance with the determined transparency value, and/or will additionally include the imposter region in the place of the first region.

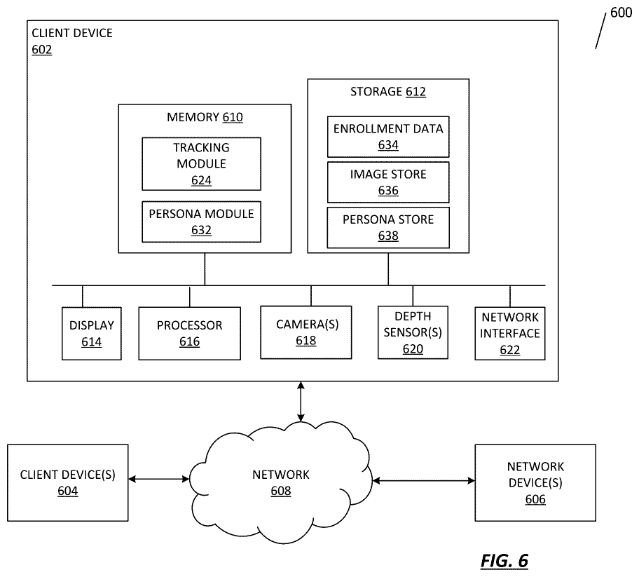

Referring to FIG. 6, a simplified network diagram 600 including a client device 602 is presented. The client device may be utilized to generate a virtual representation of a subject. The network diagram 600 includes client device 602 which may include various components. Client device 602 may be part of a multifunctional device, such as a phone, tablet computer, personal digital assistant, portable music/video player, wearable device, head mounted device, base station, laptop computer, desktop computer, mobile device, network device, or any other electronic device that has the ability to capture image data.

Client device 602 may include one or more processors 616, such as a central processing unit (CPU). Processor(s) 616 may include a system-on-chip such as those found in mobile devices and include one or more dedicated graphics processing units (GPUs) or other graphics hardware. Further, processor(s) 616 may include multiple processors of the same or different type. Client device 602 may also include a memory 610. Memory 610 may include one or more different types of memory, which may be used for performing device functions in conjunction with processor(s) 616. Memory 610 may store various programming modules for execution by processor(s) 616, including tracking module 624, persona module 632, and potentially other various applications.

Client device 602 may also include storage 612. Storage 612 may include enrollment data 634, which may include data regarding user-specific profile information, user-specific preferences, and the like. Enrollment data 634 may additionally include data used to generate virtual representations specific to the user, such as a 3D mesh representation of the user, join locations for the user, a skeleton for the user, texture or other image data, and the like. Storage 612 may also include an image store 636. Storage 612 may also include a persona store 638, which may store data used to generate virtual representations of a user of the client device 602, such as geometric data, texture data, predefined characters, and the like. In addition, persona store 638 may be used to store predefined regions used during runtime, such as an imposter region to be overlaid over a region on which a transparency treatment is applied.

In some embodiments, the client device 602 may include other components utilized for user enrollment and tracking, such as one or more cameras 618 and/or other sensors 620, such as one or more depth sensors. In one or more embodiments, each of the one or more cameras 618 may be a traditional RGB camera, a depth camera, or the like. The one or more cameras 618 may capture input images of a subject for determining 3D information from 2D images. Further, cameras 618 may include a stereo or other multicamera system.

Although client device 602 is depicted as comprising the numerous components described above, and one or more embodiments, the various components and functionality of the components may be distributed differently across one or more additional devices, for example across a network. For example, in some embodiments, any combination of storage 612 may be partially or fully deployed on additional devices, such as network device(s) 606, a base station, an accessory device, or the like.

According to one or more embodiments, client device 602 may include a network interface 622 which provides communication and data transmission between client device 602 and other devices across the network 608, such as other client devices 604 or network device 606. In some embodiments, the persona module 632 may generate virtual representation data for transmission to a receiving device, such as client device(s) 604, where the virtual representation data may be used to generate a composite image of the subject persona in the view of the physical environment of the client device(s) 604. Similarly, client device 602 may include a display 614,

Further, in one or more embodiments, the features depicted in client device 602 may be distributed across multiple devices in the network diagram 600. For example, input images may be captured from cameras on accessory devices communicably connected to the client device 602 across network 608, or a local network. As another example, some or all of the computational functions described as being performed by computer code in memory 610 may be offloaded to an accessory device communicably coupled to the client device 602, a network device such as a server, or the like. Accordingly, although certain calls and transmissions are described herein with respect to the particular systems as depicted, in one or more embodiments, the various calls and transmissions may be differently directed based on the differently distributed functionality. Further, additional components may be used, or some combination of the functionality of any of the components may be combined.

There are many different types of electronic systems that enable a person to sense and/or interact with various XR environments. Examples include: head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

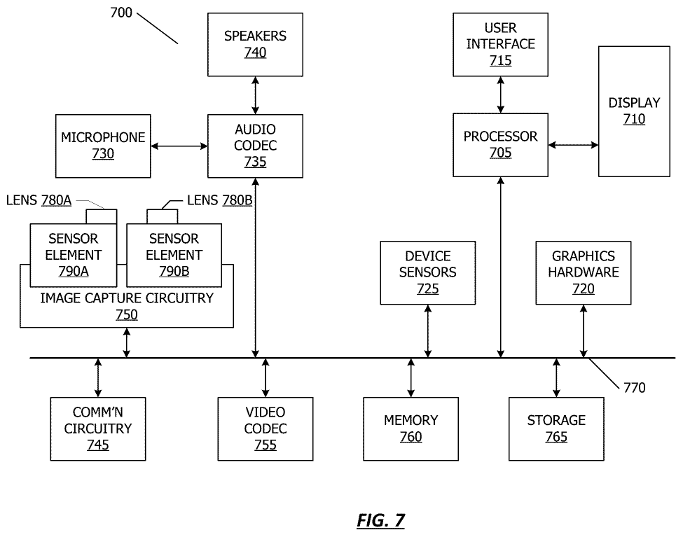

Referring now to FIG. 7, a simplified functional block diagram of illustrative multifunction electronic device 700 is shown according to one embodiment. Each of the electronic devices may be a multifunctional electronic device or may have some or all of the described components of a multifunctional electronic device described herein. Multifunction electronic device 700 may include some combination of processor 705, display 710, user interface 715, graphics hardware 720, device sensors 725 (e.g., proximity sensor/ambient light sensor, accelerometer and/or gyroscope), microphone 730, audio codec 735, speaker(s) 740, communications circuitry 745, digital image capture circuitry 750 (e.g., including camera system), memory 760, storage device 765, and communications bus 770. Multifunction electronic device 700 may be, for example, a mobile telephone, personal music player, wearable device, tablet computer, and the like.

Processor 705 may execute instructions necessary to carry out or control the operation of many functions performed by device 700. Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen, touch screen, and the like. Processor 705 may also, for example, be a system-on-chip such as those found in mobile devices and include a dedicated GPU. Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include one or more lens assemblies, such as 780A and 780B. The lens assemblies may have a combination of various characteristics, such as differing focal length and the like. For example, lens assembly 780A may have a short focal length relative to the focal length of lens assembly 780B. Each lens assembly may have a separate associated sensor element 790. Alternatively, two or more lens assemblies may share a common sensor element. Image capture circuitry 750 may capture still images, video images, enhanced images, and the like. Output from image capture circuitry 750 may be processed, at least in part, by video codec(s) 755 and/or processor 705, and/or graphics hardware 720, and/or a dedicated image processing unit or pipeline incorporated within circuitry 745. Images so captured may be stored in memory 760 and/or storage 765.

Memory 760 may include one or more different types of media used by processor 705 and graphics hardware 720 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory computer-readable storage mediums, including, for example, magnetic disks (fixed, floppy, and removable) and tape, optical media such as CD-ROMs and digital video discs (DVDs), and semiconductor memory devices such as Electrically Programmable Read-Only Memory (EPROM), and Electrically Erasable Programmable Read-Only Memory (EEPROM). Memory 760 and storage 765 may be used to tangibly retain computer program instructions or computer readable code organized into one or more modules and written in any desired computer programming language. When executed by, for example, processor 705, such computer program code may implement one or more of the methods described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2 and 4-5 or the arrangement of elements shown in FIGS. 1, 3, and 6-7 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain English equivalents of the respective terms “comprising” and “wherein.”

1. A method comprising:
obtaining sensor data corresponding to a subject; and
generating a virtual representation of the subject based on the sensor data, comprising:
determining, for a particular frame of the sensor data, a velocity of at least a portion of the subject; and
applying, for the particular frame, a transparency treatment to a portion of a virtual representation of the subject in accordance with the determined velocity.

2. The method of claim 1, wherein the determined velocity comprises a translational velocity of a head mounted device.

3. The method of claim 1, wherein the at least a portion of the virtual representation comprises a shoulder region of the virtual representation.

4. The method of claim 1, wherein the virtual representation is further generated based on enrollment data for the subject.

5. The method of claim 4, wherein the virtual representation of the subject is generated by: determining a shoulder width from the enrollment data and a shoulder position for the subject; and
generating a subject-specific shoulder region using a generic virtual shoulder region, the shoulder width, and the shoulder position.

6. The method of claim 1, wherein applying the transparency treatment to the portion of the virtual representation of the subject comprises:
determining that the velocity satisfies a predetermined threshold,
determining a transparency parameter in accordance with the velocity, and
applying a shader to the portion of the virtual representation using the transparency parameter.

7. The method of claim 6, wherein applying the shader to the portion of the representation comprises:
in accordance with the velocity being greater than the predetermined threshold, increasing transparency of the portion of the virtual representation.

8. The method of claim 6, wherein applying the shader to the portion of the representation comprises:
in accordance with the velocity being greater than the predetermined threshold, reducing transparency of the portion of the virtual representation.

9. A non-transitory computer readable medium comprising computer readable code executable by one or more processors to:
obtain sensor data corresponding to a subject; and
generate a virtual representation of the subject based on the sensor data, comprising computer readable code to:
determine, for a particular frame of the sensor data, a velocity of at least a portion of the subject; and
apply, for the particular frame, a transparency treatment to a portion of a virtual representation of the subject in accordance with the determined velocity.

10. The non-transitory computer readable medium of claim 9, wherein the determined velocity comprises a translational velocity of a head mounted device.

11. The non-transitory computer readable medium of claim 9, wherein the portion of the virtual representation comprises a shoulder region of the virtual representation.

12. The non-transitory computer readable medium of claim 9, wherein the virtual representation is further generated based on enrollment data for the subject.

13. The non-transitory computer readable medium of claim 12, wherein the virtual representation of the subject is generated by:
determining a shoulder width from the enrollment data and a shoulder position for the subject; and
generating a subject-specific shoulder region using a generic virtual shoulder region, the shoulder width, and the shoulder position.

14. The non-transitory computer readable medium of claim 9, wherein the virtual representation of the subject is generated based on enrollment image data from which a geometry and texture of the subject are derived.

15. The non-transitory computer readable medium of claim 9, further comprising computer readable code to:
generate virtual representation data based on the sensor data and the virtual representation of the subject; and
transmit the virtual representation data to a receiving device.

16. A system comprising:
one or more processors; and
one or more computer readable media comprising computer readable code executable by the one or more processors to:
obtain sensor data corresponding to a subject; and
generate a virtual representation of the subject based on the sensor data, comprising computer readable code to:
determine, for a particular frame of the sensor data, a velocity of at least a portion of the subject; and
apply, for the particular frame, a transparency treatment to a portion of a virtual representation of the subject in accordance with the determined velocity.

17. The system of claim 16, wherein the determined velocity comprises a translational velocity of a head mounted device.

18. The system of claim 16, wherein the portion of the virtual representation comprises a shoulder region of the virtual representation.

19. The system of claim 16, wherein the computer readable code to apply the transparency treatment to the portion of the virtual representation of the subject comprises computer readable code to:
determine that the velocity satisfies a predetermined threshold,
determine a transparency parameter in accordance with the velocity, and
apply a shader to the portion of the virtual representation using the transparency parameter.

20. The system of claim 16, wherein the virtual representation of the subject is generated based on enrollment image data from which a geometry and texture of the subject are derived.
